(19) United States
(12) Patent Application Publication
(10) Pub. No.: US 2017/0173593 A1
(43) Pub. Date: Jun. 22, 2017

(54) ELECTROSTATIC FLUID FILTER AND SYSTEM

(71) Applicant: Peter Woods, Grimsby (CA)

(72) Inventor: Peter Woods, Grimsby (CA)

(21) Appl. No.: 14/757,337

(22) Filed: Dec. 18, 2015

(51) Int. Cl. B03C 5/02

(52) U.S. Cl. CPC B03C 5/02; B03C 2201/32; B03C 2201/24

(57) ABSTRACT

Certain exemplary aspects of the present disclosure are directed towards an apparatus for electrostatic fluid filtration. The apparatus utilizing alternating positive and negative electrodes in conjunction with filter media there between to filter contaminants from a fluid flow.

### SUMMARY

Various example embodiments are directed to apparatuses, systems, and related methods involving electrostatic fluid filtration suitable for removing insoluble contaminants known to produce undesirable varnish and sludge in non-conductive fluids (e.g., dielectric fluids). The electrostatic fluid filtration system may also remove water and sub-micron contaminants from the fluid.

Various embodiments of the present disclosure are directed to an apparatus comprising: a conductive housing, a plurality of positive electrodes, and a plurality of negative electrodes alternately disposed between the positive electrodes within the conductive housing. Each alternately disposed pair of positive and negative electrodes form an electrostatic field between each of the positive and negative electrodes in response to the positive electrodes receiving a positive voltage. The electrostatic field acts on contaminants within a fluid flow extending between the positive and negative electrodes to filter the contaminants from the fluid. A plurality of removable filter cartridges including a first filter media extending between each of the positive and negative electrodes within the conductive housing removes additional contaminants from a fluid flow extending between the positive and negative electrodes. A power supply, electrically coupled to the positive electrodes, transmit the positive voltage to the positive electrodes. Similarly, the conductive housing and the negative electrodes are electrically coupled to one another to form an electrical ground. In further more specific embodiments, the plurality of positive and negative electrodes includes surface area maximizing features.

One or more of these embodiments may be particularly applicable, for example, to fluid contamination, and may more particularly relate to the removal of contaminants from common fluids, including dielectric fluids. Such removal of contaminants will allow for the recycling/reuse of such fluids.

Various example embodiments are directed to a system for removing insoluble contaminants from a nonconductive fluid. The system comprising an electrostatic fluid filtration device, a power supply, a fluid flow pump, a contaminant sensor, and controller circuitry. The electrostatic fluid filtration device includes a conductive housing, a plurality of positive electrodes, a plurality of negative electrodes, and a plurality of removable filter cartridges. The plurality of negative electrodes is alternately disposed between the positive electrodes within the conductive housing. Each alternately disposed pair of positive and negative electrodes form an electrostatic field between each of the positive and negative electrodes in response to the positive electrodes receiving a positive voltage. The electrostatic field acts on contaminants within a fluid flow extending between the positive and negative electrodes to filter the contaminants from the fluid. The conductive housing and the negative electrodes are electrically coupled to one another to form an electrical ground. The plurality of removable filter cartridges includes a first filter media extending between each of the positive and negative electrodes within the conductive housing. The filter media removes additional contaminants from a fluid flow extending between the positive and negative electrodes. The plurality of positive and negative electrodes and the conductive housing direct the flow of fluid within the conductive housing axially in response to a first electrostatic field between a first pair positive and negative electrodes with a first electrical charge. The plurality of positive and negative electrodes and the conductive housing further direct the flow radially inwards away from an outer wall of the conductive housing in response to a second electrostatic field between a second pair of positive and negative electrodes with an electrical charge different then the first electrostatic field. The power supply electrically coupled to the plurality of positive and negative electrodes produce a series of alternating electrical fields between each pair of electrode plates. The fluid flow pump coupled to an inlet of the conductive housing directs a flow of fluid into the electrostatic fluid filtration device. The contaminant sensor, coupled to the inlet or an outlet of the conductive housing, detects the contaminant level of the fluid flowing past the contaminant sensor. The controller circuitry receives data from the fluid flow pump indicative of a fluid flow rate, data from the contaminant sensor indicative of fluid contaminant level, and data indicative of an output of the power supply.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description in connection with the accompanying drawings, in which:

FIGS. 1A-B are isometric views of an electrostatic cartridge apparatus, consistent with various aspects of the present disclosure;

FIG. 2A is a top view of an electrostatic fluid filtration system, consistent with various aspects of the present disclosure;

FIG. 2B is a cross-sectional side view of the electrostatic fluid filtration system of FIG. 2A, consistent with various aspects of the present disclosure;

FIG. 3A is a side view of an insulated high voltage module, consistent with various aspects of the present disclosure;

FIG. 3B is a cross-sectional side view of the insulated high voltage module of FIG. 3A, consistent with various aspects of the present disclosure;

FIG. 4 is a top view of a positive electrode of an electrostatic cartridge apparatus, consistent with various aspects of the present disclosure;

FIG. 5 is a top view of a negative electrode of an electrostatic cartridge apparatus, consistent with various aspects of the present disclosure;

FIG. 6 is a top view of a top ground electrode of an electrostatic cartridge apparatus, consistent with various aspects of the present disclosure; and

FIGS. 7A-B are front and rear views, respectively, of an electrostatic liquid filtration system, consistent with various aspects of the present disclosure.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems, and methods for filtration of fluid contamination within a liquid. Specific embodiments, including electrostatic fluid filtration systems, are believed to be particularly beneficial to the removal of sub-micron contaminants. The formation of sub-micron contaminants (e.g., varnish and sludge) in non-conductive fluids (e.g. dielectric fluids) will cause damage, over time, to machinery utilizing such fluids. While the present disclosure is not necessarily so limited, various aspects of the disclosure may be appreciated through a discussion of examples using this context.

Fluid contamination in hydraulic and lubrication systems will cause excessive wear, and/or machinery/system failure over time. Common contamination in industrial systems includes varnish contamination, which is at least in part a by-product of oil-degradation in these systems. The occurrence of oil-degradation, and the resultant varnish deposition, has been associated with tighter filtration requirements, higher flow rates for lubricating oil, increased machinery operating temperatures, and industry migration to Group II based oil formulations. By utilizing electrostatic fluid filtration systems disclosed herein, varnish, sludge, and other deposit formations will be filtered from the fluids utilized in industrial machinery systems, thereby maintaining system reliability, and production continuity in a manufacturing or production environment. Various industrial systems particularly susceptible to damage associated with contaminant build-up in hydraulic and lubrication fluids include bearings and servos.

Mechanical components in industrial machinery are particularly susceptible to contaminant deposition on metal surfaces, such as reservoirs, bearings, and servo-valves. These deposits are often thin, insoluble films. Many contaminants associated with oil-degradation, such as varnish, have high molecular weights and are insoluble in oil. It has been discovered that contaminants, such as varnish insolubles are more than 75 percent soft contaminants that are less than 1 micron in size and are not detected by traditional laboratory analysis. Due to the contaminants sub-micron size, traditional mechanical filters (effective to ˜3 micron) due not remove the contaminants from hydraulic and lubrication fluids. Without filtration from the fluid, the polar affinities of the sub-micron insoluble compounds, over time, draws the contaminants to proximal machine surfaces and are eventually deposited thereon. Upon deposition, deposited surfaces may exhibit a gold or tan color, gradually deepening over time to darker gum-like layers that eventually develops into varnish. In hydraulic applications, for example, the varnish will alter the frictional characteristics of the machine surface causing increased wear to adjacent contacting components. In lubrication applications, for example, the altered machine surface will cause increased turbulence to the flow of lubricant decreasing efficiency and/or increasing operating temperature.

The build-up of sub-micron insoluble contamination particles in industrial machinery will also create lubricant imbalances. Lubricant imbalances, over time, will further accelerate oil-degradation and additional contaminant propagation. Such lubricant imbalances contribute to a number of factors including oxidation, cross- and chemical-contamination, micro-dieseling and adiabatic compression. The difficult of reducing and/or eliminating such factors all together in any lubricant or hydraulic application would be exceedingly difficult and likely cost prohibitive. Embodiments of the present disclosure reduce the need to address such lubricant imbalances in a given application by removing the harmful by-product contaminants from the system prior to depositing to machine surfaces in the system and resulting wear and damage.

Contaminant deposits on machine surfaces can cause numerous operational issues by interfering with the reliable performance of the fluid and the machine's mechanical movements. They can also contribute to wear and corrosion or simply just cling to surfaces. In one specific example, contaminant build-up will prevent hydrodynamic lubrication of a bearing surface, resulting in bearing failure. In yet other applications, contamination in hydraulic applications will cause restriction and stiction in moving mechanical parts such as servo or directional valves, and/or increased component wear due to varnish's propensity to attract dirt and solid particle contaminants. In heat exchanger applications, contamination will reduce heat transfer due to varnish's insulation effect. In various applications, catalytic deterioration of the lubricant will reduce the affective life of the lubricant increasing operating costs. Contaminants has also been discovered to plug small oil flow orifices and oil strainers, increase friction, heat and energy, damage mechanical seals, cause bearing failure, etc.

Various embodiments of the present disclosure are directed to an apparatus comprising: a conductive housing, a plurality of positive electrodes, and a plurality of negative electrodes alternately disposed between the positive electrodes within the conductive housing. Each alternately disposed pair of positive and negative electrodes form an electrostatic field between each of the positive and negative electrodes in response to the positive electrodes receiving a positive voltage. The electrostatic field acts on contaminants within a fluid flow extending between the positive and negative electrodes to filter the contaminants from the fluid. A plurality of removable filter cartridges including a first filter media extending between each of the positive and negative electrodes within the conductive housing removes additional contaminants from a fluid flow extending between the positive and negative electrodes. A power supply, electrically coupled to the positive electrodes; transmit the positive voltage to the positive electrodes. Similarly, the conductive housing and the negative electrodes are electrically coupled to one another to form an electrical ground. In further more specific embodiments, the plurality of positive and negative electrodes includes surface area maximizing features. In yet further embodiments, such surface area maximizing features of the plurality of positive and negative electrodes include one or more of the following: dimples, texture, and corrugation.

In certain specific embodiments, a plurality of positive and negative electrodes and a conductive housing direct the flow of fluid within the conductive housing axially in response to a first electrostatic field between a first pair of positive and negative electrodes with a first electrical charge, and to flow radially inwards away from an outer wall of the conductive housing in response to a second electrostatic field between a second pair of positive and negative electrodes with a second electrical charge different then the first electrostatic field. In some embodiments, another removable filter cartridge including a second filter media captures water from the fluid flow within the apparatus.

In many embodiments, a plurality of negative electrodes has a circumference greater than a circumference of each of a plurality of positive electrodes. In such embodiments, each of the plurality of negative electrodes may be electrically and mechanically coupled to the conductive housing. In yet other embodiments, each of the plurality of positive electrodes may be electrically coupled to one another by conductive off-sets, and each of the plurality of negative electrodes are electrically coupled to one another by conductive off-sets.

In specific embodiments of an electrostatic fluid filtration apparatus, consistent with various aspects of the present disclosure, a conductive housing of the apparatus further includes a fluid inlet positioned at a distal end of the conductive housing. The fluid inlet receives a flow of contaminated fluid into the conductive housing, and a fluid outlet positioned at a proximal end of the conductive housing to output a flow of de-contaminated fluid from the conductive housing. In various embodiments, the conductive housing may take a number of shapes including a cylinder, a cube, etc.

Various example embodiments are directed to a system for removing insoluble contaminants from a nonconductive fluid. The system comprising an electrostatic fluid filtration device, a power supply, a fluid flow pump, a contaminant sensor, and controller circuitry. The electrostatic fluid filtration device includes a conductive housing, a plurality of positive electrodes, a plurality of negative electrodes, and a plurality of removable filter cartridges. The plurality of negative electrodes is alternately disposed between the positive electrodes within the conductive housing. Each alternately disposed pair of positive and negative electrodes form an electrostatic field between each of the positive and negative electrodes in response to the positive electrodes receiving a positive voltage. The electrostatic field acts on contaminants within a fluid flow extending between the positive and negative electrodes to filter the contaminants from the fluid. The conductive housing and the negative electrodes are electrically coupled to one another to form an electrical ground. The plurality of removable filter cartridges includes a first filter media extending between each of the positive and negative electrodes within the conductive housing. The filter media removes additional contaminants from a fluid flow extending between the positive and negative electrodes. The plurality of positive and negative electrodes and the conductive housing direct the flow of fluid within the conductive housing axially in response to a first electrostatic field between a first pair positive and negative electrodes with a first electrical charge. The plurality of positive and negative electrodes and the conductive housing further direct the flow radially inwards away from an outer wall of the conductive housing in response to a second electrostatic field between a second pair of positive and negative electrodes with an electrical charge different then the first electrostatic field. The power supply electrically coupled to the plurality of positive and negative electrodes produce a series of alternating electrical fields between each pair of electrode plates. The fluid flow pump coupled to an inlet of the conductive housing directs a flow of fluid into the electrostatic fluid filtration device. The contaminant sensor, coupled to the inlet or an outlet of the conductive housing, detects the contaminant level of the fluid flowing past the contaminant sensor. The controller circuitry receives data from the fluid flow pump indicative of a fluid flow rate, data from the contaminant sensor indicative of fluid contaminant level, and data indicative of an output of the power supply.

In more specific embodiments of the system for removing insoluble contaminants from a nonconductive fluid, the controller circuitry further includes communication circuitry to transmit data received by the controller circuitry to remote computer circuitry. In further embodiments, the controller circuitry controls the fluid flow rate of a fluid flow pump, and output of a power supply in response to data received from a contaminant sensor indicative of the contaminant level of the fluid flow.

Detailed embodiments of the system for removing insoluble contaminants from a nonconductive fluid may further include a water sensor, coupled to an inlet of the electrostatic fluid filtration device that transmits data to controller circuitry indicative of the existence of water within the fluid flow entering the electrostatic fluid filtration device. The controller circuitry, in response to receiving data from the water sensor indicative of the existence of water within the fluid flow, shuts down the fluid flow pump, and output of the power supply, and indicates to an operator the need to insert another removable filter cartridge including a second filter media to capture water from the fluid flow within the electrostatic fluid filtration device.

Controller circuitry of the present disclosure may store data received from the fluid flow pump, the contaminant sensor, and the power supply, and based on the stored data characterize the degradation of the fluid being filtered by the electrostatic fluid filtration device. Optionally, the controller circuitry may indicate to an operator that a fluid change is necessary once the degradation of the fluid exceeds a threshold level.

Various embodiments of the system for removing insoluble contaminants from a nonconductive fluid including an electrostatic fluid filtration device that reverses corrosion on machine surfaces in contact with the fluid by reducing the contaminant level within the fluid below a contaminant saturation level; wherein, contaminants comprising the corrosion are drawn from the machine surfaces into the fluid whereby the contaminants are filtered by the electrostatic fluid filtration device. Optionally, the system may include a reservoir that holds the fluid. The reservoir may be coupled to the rest of the system in a number of configurations, including for example, it may be coupled to an inlet and outlet of the electrostatic fluid filtration device in a kidney loop configuration.

In various specific/experimental embodiments of the present disclosure, a electrostatic fluid filtration system removes sub micron insoluble contaminants known to cause both varnish and sludge from non-conductive fluids such as dielectric fluids. The electrostatic fluid filtration system removes both water and other contaminants from a target fluid (e.g. a dielectric fluid) by directing the target fluid through a stack of electrostatic filtration cartridges or an interchangeable water removal cartridge. The number of electrostatic filtration cartridges in series or parallel may vary based on the particular application, the contamination level of the fluid, and the desired filtering time to a desired purity. The electrostatic filtration cartridges apply an electrostatic charge to the fluid flowing through the cartridges. The electrostatic charge has no affect on dielectric fluids flowing through the electrostatic filtration cartridges. However, conductive materials such as contaminants have a force induced upon them by the electrostatic charge, which allows for the filter and capture of such contaminants.

To increase the efficiency of the electrostatic fluid filtration system, control circuitry may be utilized to control the flow rates of fluid through the system by controlling one or more fluid pumps via power supply inputs thereto. The system may further utilize a number of sensors to determine the condition of the fluid before and after filtration to determine the efficacy and to vary the filtering properties of the system. Inline water sensors may be utilized adjacent the input and output of the system to determine water contamination levels of the fluid. Similarly, inline particle counters can be utilized to determine sub-micron contaminants in the fluid before and after filtration. It is to be understood that a myriad of sensors may be utilized to further improve the efficiency and efficacy of the electrostatic fluid filtration system, and such systems are readily encompassed by the present disclosure. Further examples of sensors that various embodiments of the present disclosure may utilize include, but not necessarily limited to: an oil temperature sensor, a flow switch, a float switch, a digital pressure gauge, a digital vacuum gauge. In addition to optimizing the efficiency of the system, the control circuitry may also modify the operating parameters of the machine utilizing the electrostatic fluid filtration system to reduce fluid-degradation (increase fluid life) and to minimize wear on such machines by limiting functionality or shutting down the machine during fluid over-temperature events. It has been discovered that increased fluid temperature in various hydraulic and lubrication systems are directly associated with abnormal machine wear, and increased breakdown likelihood.

In application specific embodiments, one or more conductive cylindrical filtration units may be utilized in series or in parallel (depending on application contamination levels). In many contaminant-intensive applications, the electrostatic fluid filtration system may include a number of electrostatic filtration cartridges in parallel that may be replaced periodically when filtration efficiency of the system degrades. In further more specific embodiments, the control circuitry may be communicatively coupled via wired/wireless communication to other computer circuitry allowing for remote, real-time updates of electrostatic fluid filtration system status. These updates may include information on the filtration system including contamination filtration efficiency, oil health and remaining useable life, etc. based on the received sensor data.

Embodiments of the electrostatic fluid filtration system may further include electronic data storage communicatively coupled to the controller circuitry. During filter operation, the controller circuitry may record various data on the fluid received from the sensor(s) communicating with the controller circuitry. This data may be recalled by a electrostatic fluid filtration system user to determine when fluids need to be changed, or filter cartridges have reached the end of their useful life. In yet further more specific embodiments, the controller circuitry may utilize stored sensor data to optimize fluid filtration by modifying the controller circuitry inputs to the system, and even extend the life of the machine utilizing the filtered fluids by adjusting the machine's performance characteristics in view of the status of the fluid therein. For example, where the electrostatic fluid filtration system determines that the fluid exiting the system does not meet a threshold purity, the machine utilizing the fluid may be automatically shut-down to prevent damage. As another example, based on historical data saved by the controller circuitry, the electrostatic fluid filtration system may determine that the fluid being filtered is near the end of its useful life. In response to this determination, the machine operating characteristics may be modified to minimize further fluid degradation (and possible machine damage) until the fluids may be replaced.

In more basic embodiments of the present disclosure, an electrostatic fluid filtration system may only have a single filter cartridge compartment. During operation of the electrostatic fluid filtration system, with an electrostatic filter cartridge installed in the cartridge compartment, the target fluid will be electrostatically cleaned. When the controller circuitry receives data from a water sensor in the system indicative of the presence of water levels above a desired threshold level, the controller circuitry will initiate a water contamination state. In the water contamination state, the controller circuitry may: shut-down the machine utilizing the water contaminated fluid to prevent damage, alert an operator of the state, and/or automatically or manual (via an operator) operate in a water removal mode by switching the electrostatic filter cartridge with a water removal filter cartridge. After the water sensor data indicates that the water levels are back within a desired threshold, normal operation may resume by replacing the water removal filter cartridge with the electrostatic filter cartridge.

Many embodiments of the electrostatic fluid filtration system may include the use of controller circuitry to monitor contaminant particle counts (via inline particle counter or other similar sensor) in the filtered fluid for filter efficacy analysis. This data may be monitored by an operator at the controller circuitry, or remotely (where the controller circuitry is communicatively coupled via wired/wireless communications to other computer circuitry). In such embodiments, all functions of the electrostatic fluid filtration system may be monitored by the controller circuitry, including: water and particle contamination), pressure (vacuum), filter life, leak detection, fluid flow, filter current levels, filter high voltage levels, oil temperature, system total run hours, among others.

The electrostatic fluid filtration system may include a sealable conductive housing with a replaceable cartridge comprising a number of spaced parallel electrode plates and sections of a filtration media placed between the electrode plates. In the filtration unit, the target fluid flows axially and radially through the filtration media that is positioned between the electrode plates in a generally horizontal flow pattern. This forces the target fluid to traverse alternating multiple energy fields in a linear fashion and in a single pass through the contaminant filtration unit. The energy fields created by the alternating electrode plates act on conductive contaminants to filter and/or trap such contaminants in the filtration unit, while allowing the dielectric fluid to freely traverse through the electrostatic fluid filtration system. Proper treatment of contaminated fluid may be accomplished by controlling the amount of time the fluid remains in the filtration unit, as well as increasing the filter surface area that the target fluid is exposed to during treatment.

In another specific/experimental embodiment, an electrostatic fluid filtration system for removing molecularly insoluble contaminants known to cause both varnish and sludge from fluids such as dielectric fluids is disclosed. The electrostatic fluid filtration system including a housing that houses: control circuitry, one or more pumps, one or more high voltage power supplies, an inline water sensor, an inline particle counter, a flow switch, a float switch, an oil temperature sensor, wired/wireless communication circuitry for remote monitoring and system diagnostics of the system, a digital pressure/vacuum gauge, and an electrostatic filtration unit. The filtration unit comprises a conductive housing, one or more replaceable cartridge positioned within the housing, and a removable lid to facilitate replacement of the replaceable cartridges. It is further to be understood that in very other embodiments that the electrostatic fluid filtration system need not be contained within a single housing and in some larger filtering applications a single housing for all of the above mentioned components may not be feasible.

In many embodiments, the electrostatic filtration unit includes a conductive housing with inlet and outlet ports being located opposite from one another on the housing. A replaceable cartridge including a number of electrode plates that are positioned inside the electrically conductive housing. Each of the adjacent electrode plates is oppositely electrically charged (negative or positive D.C. voltage). A filtration media is placed between each oppositely charged electrode plate pairing. For treatment, a fluid is pumped at a relatively low pressure into the filtration unit at the inlet port. The pressure of the fluid to be treated is greater than a head pressure of a machine the electrostatic fluid filtration system is connected thereto.

Various embodiments of the present disclosure improve conductivity between the electrically conductive housing and the replaceable filter cartridges utilizing a twist lock connection that ensures positive contact there between. This electrically conductive connection is critical to the efficacy of the filter unit as the positive electrode plates are electrically charged. The negative electrode plates are connected through a section of the conductive housing wall. The twist lock connection allows for easy removal of filter cartridges from the conductive housing where required for maintenance or replacement, while also providing increased conductivity between the conductive housing and the electrode plates reducing power losses and increasing contaminant capture rates during filter unit operation.

In specific embodiments requiring increased contaminant capture rates while maintaining smaller space requirements, electrode plates may be formed to increase surface area of the electrodes plate (e.g. corrugation, dimples, texturing, etc.). The increased area of the electrode plates will increase the strength and efficiency of the electrostatic fields between the electrode plates, thereby reducing the number of electrostatic fields, and/or time, required to clean the target fluid to a desired level. Accordingly, in various embodiments, electrode plates with varying surface areas may be utilized within the same filter housing. This varying surface area electrode plate scheme may allow a single electrostatic fluid filtration system, with a given set of filters, to clean fluids for various applications without having to replace/exchange filters specific to the removal of certain contaminants, fluid reservoir size, and/or time allowed for filtering. Importantly, the increased surface area of the electrode plates increases the efficiency of the electrostatic fluid filtration system.

In many embodiments of the present disclosure, during operation, an electrostatic fluid filtration system receives fluid to be treated through an inlet zone located at the bottom of the conductive housing. During filtration, the fluid flows axially (relative to the circular conductive housing), until it contacts an electrode plate which forces the fluid to flow radially through a filtration media that is positioned between the electrode plates until it reaches the wall of the conductive housing where the fluid momentarily flows axially until again being re-directed through another filtration media between two electrode plates. Depending on the electrostatic fluid filtration system, this flow of the fluid is repeated until the fluid has passed between each successive pairs of electrode plates and through all of the filtration media, after which the de-contaminated fluid exits the conductive housing via an outlet port.

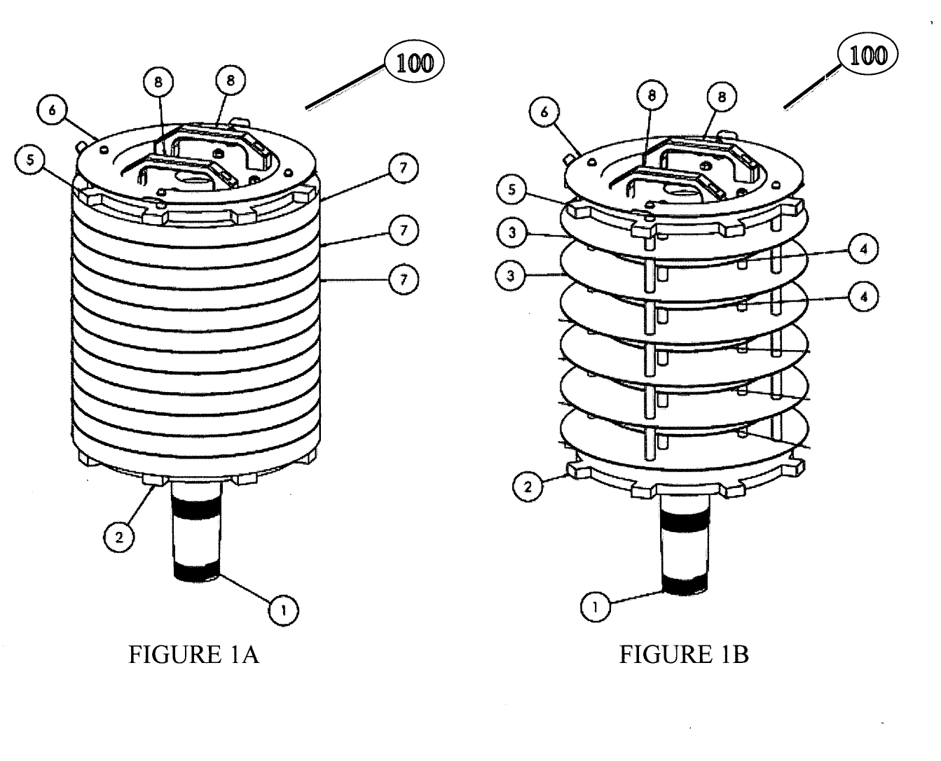

Turning now to the figures, various embodiments of the present disclosure are presented by way of the illustrations. FIGS. 1A-B are isometric views of an electrostatic filter cartridge 100 of an electrostatic fluid filtration system, with and without electrostatic filter media 7 (also referred to as filter media) installed, respectively. The insulated high voltage module 1 delivers high voltage from a power supply to the conductive housing. The bottom filter plate 2 mounts the filter media 7 (which may be either conventional or non-conventional filter media; e.g., cellulose, reticulated foam, glass fiber, paper) to the insulated high voltage module 1, which in some embodiments utilizes a twist lock connection allowing for more efficient electrical conduction between the high voltage module 1 and negative electrodes 3 and positive electrodes 4 of the filtration system. A top filter plate 5 is located at the top of the electrostatic cartridge apparatus, with the bottom and top filter plates, 2 and 5 respectively, sandwiching the filter media 7 and positive and negative electrodes (4 and 3). A top ground plate 6 coupled to the top of the electrostatic filter cartridge 100 prevents electrical discharge of the high voltage flowing between the positive and negative electrodes from extending outside of the conductive housing. For ease of access of the electrostatic filter cartridge within the conductive housing for maintenance and replacement of filters, handles 8 are coupled to the top ground plate 6. In embodiments utilizing a twist lock connection. A simple rotation of the handle will release the electrostatic filter cartridge from the conductive housing and allow for access to the filters 7 within.

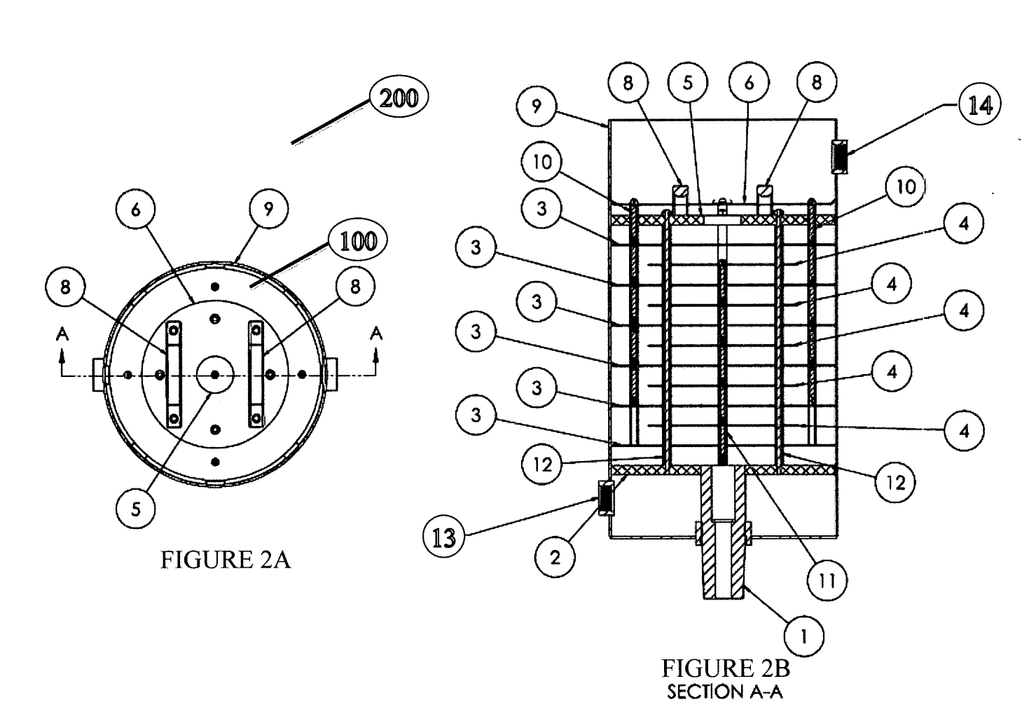

FIG. 2A is a top view of an electrostatic fluid filtration system 200, consistent with various aspects of the present disclosure. An electrostatic filter cartridge 100 is inserted within a conductive filter housing 9, with handles 8 and top ground plate 6 viewable. An access hole through the top ground plate 6 provides a fluid flow path from the exit of fluid from the electrostatic fluid filtration system 200.

FIG. 2B is a cross-sectional side view of the electrostatic fluid filtration system 200 of FIG. 2A, consistent with various aspects of the present disclosure. An insulated high voltage module 1 coupled to bottom filter plate 2 provides a positive electrical connection to a high voltage power supply. A negative electrode 3 is interconnected to the alternating negative electrodes 3 via filter negative insulated pole connectors 10 and finally connected to top ground plate 6 and the conductive filter housing 9. Positive electrodes 4 are interconnected to one another via insulated pole connectors. Insulated filter support rods 12 hold the electrostatic filter cartridge 100 rigidly together. The top ground plate 6 and a top filter plate 5 are coupled to one another with an offset. The grounding of both the top ground plate 6 and the conductive filter housing 9 prevent electrical discharge outside of the electrostatic fluid filtration system 200

In operation, a target fluid enters the conductive filter housing 9 at Fluid Inlet 13. The fluid gradually fills (at low pressure) the conductive filter housing 9 until it exits the housing via the fluid outlet 14. The target fluid flows both radially and axially throughout the conductive filter housing 9 traversing through the filter media and between the alternating positive and negative electrodes, 3 and 4. Once the conductive filter housing 9 has been pressurized by fluid, a high voltage power supply is energized and transmits power to electrostatic fields between the positive and negative electrodes. The electrostatic fluid filtration system 200 removes insoluble contamination from the fluid at a molecular level by inducing a force that separates the contamination from the fluid, which is then captured in the filter media between each pair of electrodes. In many embodiments, the electrostatic fluid filtration system 200 is monitored by controller circuitry. Relevant system data may be uploaded via wired/wireless communication to remote storage and/or remote controller circuitry.

High voltage electricity is applied to the electrostatic fluid filtration system 200 via the insulated high voltage module 1. Filter media may be mounted to the insulated high voltage module item 1 via a twist lock connection for a positive electrical connection. The remainder of the electrostatic filter cartridge 100 is grounded to the conductive filter housing 9 via top ground plate 6 completing the electrical circuit.

The close fitting tolerance of the negative electrode 3 to the conductive filter housing 9 forces the target fluid to flow inwards to the center of the filter assembly and then outwards to the conductive filter housing wall. The top filter plate 5 and the bottom filter plate 2 hold the filter ends rigidly together utilizing the filter support rods 12. The filter negative poles 10 are used to connect the negative electrodes to each other and are insulated so as to not short out to the positive electrodes 11 The filter positive poles 11 are used to connect the positive electrodes to each other and are insulated so as not to short out to the negative electrodes. The filter media can be composed of various materials both conventional and non-conventional depending on the target fluid being cleaned and the type of contamination being removed. The thickness of the filter media 7 for most applications is correlated with the voltage of the energy field created by the high voltage power supply.

During cleaning, the electrostatic fluid filtration system 200 may be monitored by controller circuitry, which controls the flow rate of the fluid through the filtration system and the characteristics of the electrostatic field created between the electrodes. In various embodiments, the controller circuitry may also monitor pressure/vacuum of the system, water content of the target fluid, detect leaks, particle count (contamination), filter life, power supply output voltage and current, target fluid temperature, and fluid flow rate through the system. As discussed in more detail above, such sensory data may be utilized by the controller circuitry to modify run characteristics of the system to optimize energy-usage, filter efficacy, and contaminant removal rate.

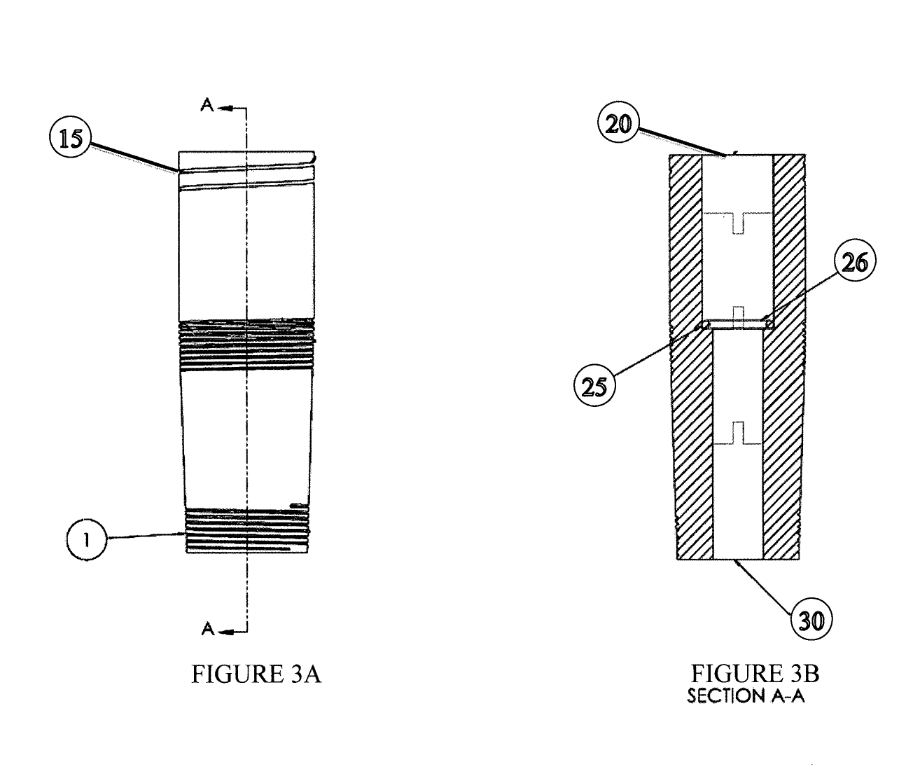

FIG. 3A is a side view of an insulated high voltage module 1, consistent with various aspects of the present disclosure. The insulated high voltage module 1 including a twist lock connection 15 for easy coupling to the remainder of the electrostatic filter cartridge 100.

FIG. 3B is a cross-sectional side view of the insulated high voltage module 1 of FIG. 3A, consistent with various aspects of the present disclosure. To operate the electrostatic field between the electrodes in the system, a high voltage power line enters through opening 30, extends through pass through 25, which includes a gasket 26 that prevents the escape of fluid within the system through opening 30. The high voltage power line then extends through opening 20 and is electrically coupled to the positive electrodes within the system.

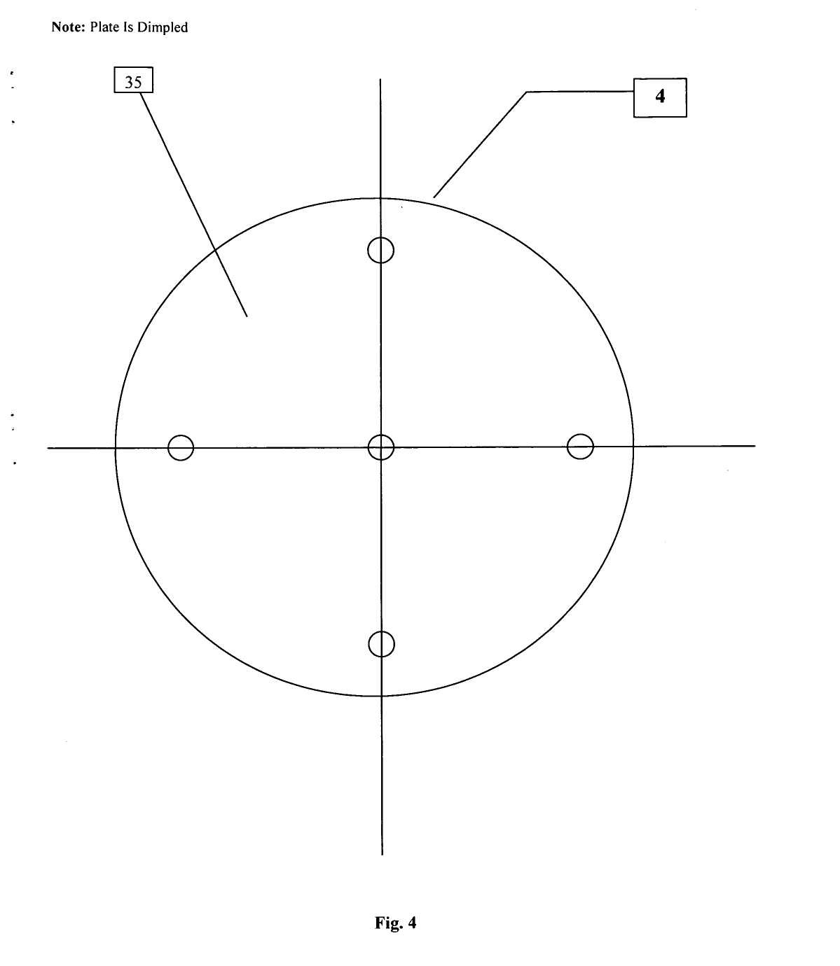

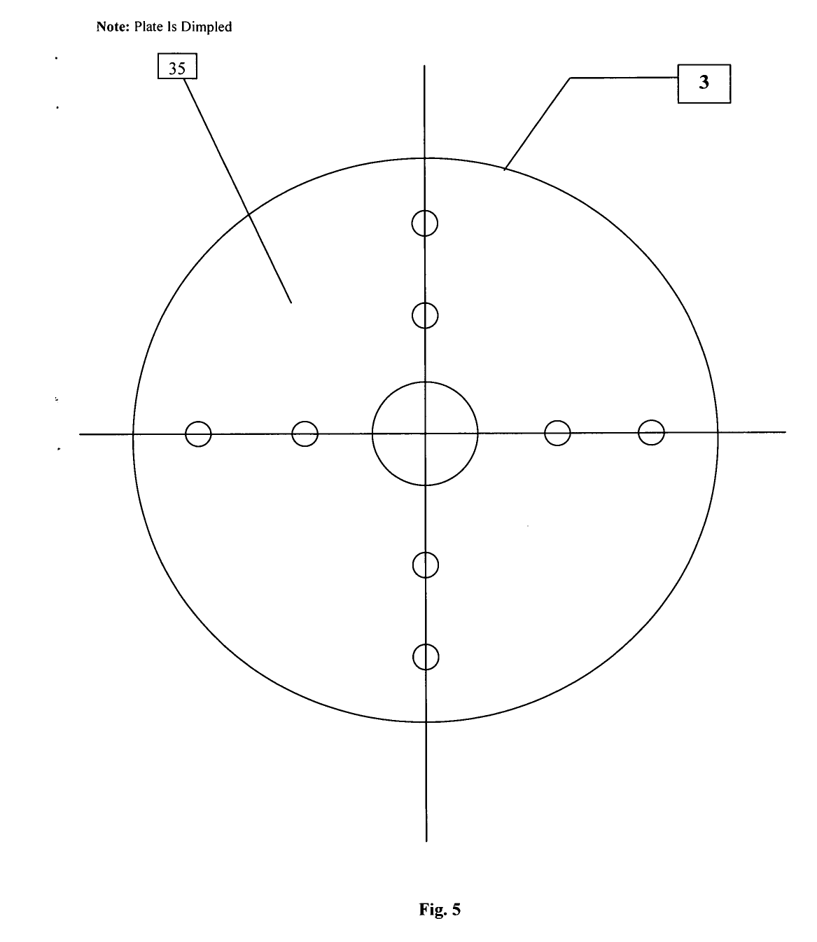

FIG. 4 is a top view of a positive electrode 4 of an electrostatic filter cartridge, consistent with various aspects of the present disclosure. FIG. 5 is a top view of a negative electrode 3 of an electrostatic filter cartridge apparatus, consistent with various aspects of the present disclosure. To increase the electrostatic field between the negative and positive electrodes in an electrostatic filtration system, the electrode plates may be formed in a manner to increase the surface area (e.g. corrugation, dimples, texturing, etc.). Dimpling 35, for example, creates a larger surface area and a more intense electrostatic field, greatly increasing the efficiency of the removal of fluid contaminants, especially sub-micron, insoluble, contaminants.

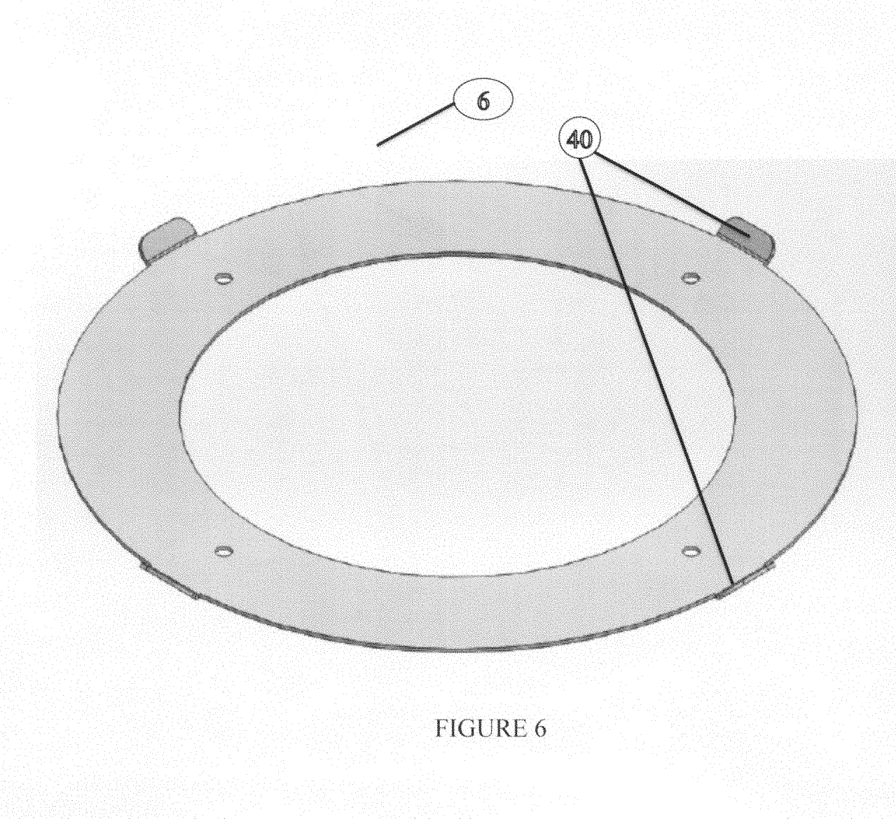

FIG. 6 is a top view of a top ground electrode 6 of an electrostatic cartridge apparatus, consistent with various aspects of the present disclosure. When installed within a conductive filter housing, spring-loaded tabs 40 positively positions the filter cartridge assembly within the conductive filter housing, while electrically coupling the top ground plate 6 to the conductive filter housing via the tabs 40. These multiple positive connections provide for greater power efficiency of the electrostatic filtration system.

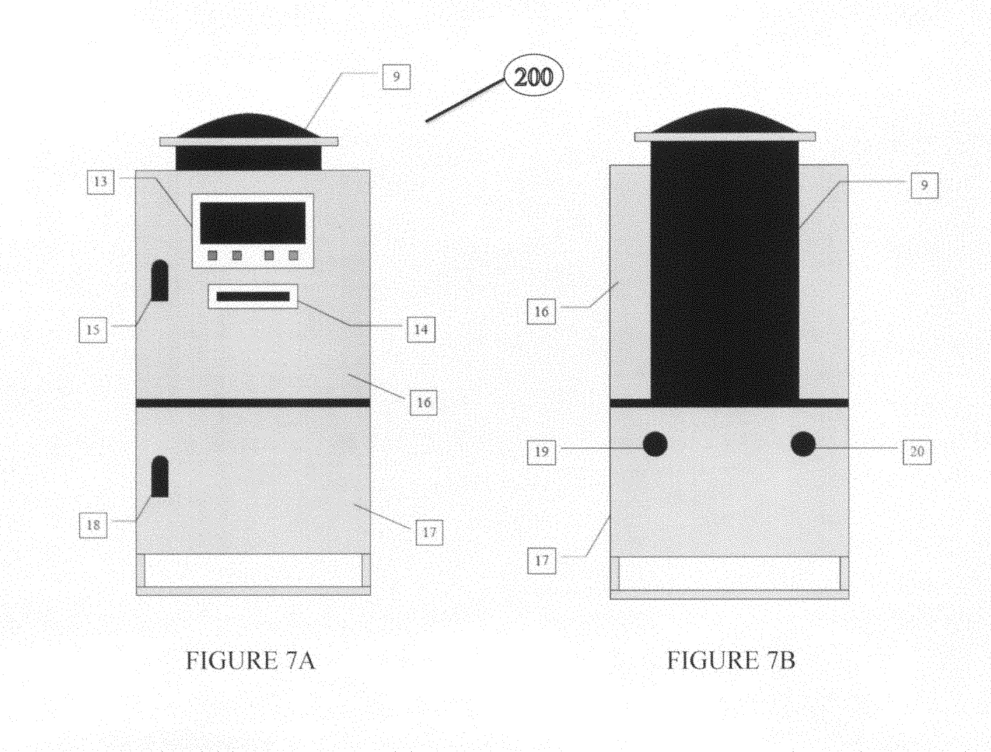

FIGS. 7A-B are front and rear views, respectively, of an electrostatic liquid filtration system 200, consistent with various aspects of the present disclosure. A housing 16 contains the entirety of the liquid filtration system including: controller circuitry display 13, particle counter display 14, electrical cabinet lock handle 15, conductive filter housing 9, hydraulic pump cabinet 17, and hydraulic pump cabinet lock handle 18. A fluid inlet 19 and fluid outlet 20 are located at the rear of the housing 16. During operation an operator may check the status of the electrostatic liquid filtration system 200 via the controller circuitry display 13 and/or particle counter display 14.

Based upon the above discussion and illustrations, those skilled in the art will readily recognize that various modifications and changes may be made to the various embodiments without strictly following the exemplary embodiments and applications illustrated and described herein. For example, though the above discussion has been primarily directed to applications related to contaminant filtration from fluids such as those used in hydraulic and lubrication systems, it should be readily apparent to one of skill in the art that such fluid filtration systems as disclosed herein are readily applicable to applications including lubricants used in power plants, marine vessels, agricultural equipment, and manufacturing including steel and primary metal manufacturing, water and wastewater treatment, injection molding, and chemical production. Such filtration may also be utilized in industries including construction, food and beverage, lumber and wood production, mining and quarry, oilfields, petrochemical, and military applications. Such modifications and applications do not depart from the true spirit and scope of various aspects of the disclosure, including aspects set forth in the claims.

What is claimed is:

1. An apparatus comprising:
a conductive housing;
a plurality of positive electrodes;
a plurality of negative electrodes, alternately disposed between the positive electrodes within the conductive housing, each alternately disposed pair of positive and negative electrodes configured and arranged to form an electrostatic field between each of the positive and negative electrodes in response to the positive electrodes receiving a positive voltage, the electrostatic field acts on contaminants within a fluid flow extending between the positive and negative electrodes to filter the contaminants from the fluid;
a plurality of removable filter cartridges including a first filter media extending between each of the positive and negative electrodes within the conductive housing, the filter media configured and arranged to remove additional contaminants from a fluid flow extending between the positive and negative electrodes;
a power supply electrically coupled to the positive electrodes, and configured and arranged to produce and transmit the positive voltage to the positive electrodes; and
the conductive housing and the negative electrodes are electrically coupled to one another, and are configured and arranged to form an electrical ground.

2. The apparatus of claim 1, wherein the plurality of positive and negative electrodes include surface area maximizing features.

3. The apparatus of claim 2, wherein the surface area maximizing features of the plurality of positive and negative electrodes include one or more of the following: dimples, texture, and corrugation.

4. The apparatus of claim 1, wherein the plurality of positive and negative electrodes and the conductive housing are configured and arranged to direct the flow of fluid within the conductive housing axially in response to a first electrostatic field between a first pair positive and negative electrodes with a first electrical charge, and to flow radially inwards away from an outer wall of the conductive housing in response to a second electrostatic field between a second pair of positive and negative electrodes with a second electrical charge different then the first electrostatic field.

5. The apparatus of claim 1 further including a another removable filter cartridge including a second filter media configured and arranged to capture water from the fluid flow within the apparatus.

6. The apparatus of claim 1, wherein each of the plurality of negative electrodes has a circumference greater than a circumference of each of the plurality of positive electrodes.

7. The apparatus of claim 6, wherein each of the plurality of negative electrodes are electrically and mechanically coupled to the conductive housing.

8. The apparatus of claim 1, wherein each of the plurality of positive electrodes are electrically coupled to one another by conductive off-sets, and each of the plurality of negative electrodes are electrically coupled to one another by conductive off-sets.

9. The apparatus of claim 1, wherein the conductive housing further includes a fluid inlet positioned at a distal end of the conductive housing configured and arranged to receive a flow of contaminated fluid into the conductive housing, and a fluid outlet positioned at a proximal end of the conductive housing configured and arranged to output a flow of de-contaminated fluid from the conductive housing.

10. The apparatus of claim 1, wherein the conductive housing is cylindrical.

11. A system for removing insoluble contaminants from a nonconductive fluid comprising:
an electrostatic fluid filtration device including
a conductive housing,
a plurality of positive electrodes,
a plurality of negative electrodes, alternately disposed between the positive electrodes within the conductive housing, each alternately disposed pair of positive and negative electrodes configured and arranged to form an electrostatic field between each of the positive and negative electrodes in response to the positive electrodes receiving a positive voltage, the electrostatic field acts on contaminants within a fluid flow extending between the positive and negative electrodes to filter the contaminants from the fluid,
the conductive housing and the negative electrodes are electrically coupled to one another, and are configured and arranged to form an electrical ground,
a plurality of removable filter cartridges including a first filter media extending between each of the positive and negative electrodes within the conductive housing, the filter media configured and arranged to remove additional contaminants from a fluid flow extending between the positive and negative electrodes, and
wherein the plurality of positive and negative electrodes and the conductive housing are configured and arranged to direct the flow of fluid within the conductive housing axially in response to a first electrostatic field between a first pair positive and negative electrodes with a first electrical charge, and to direct the flow radially inwards away from an outer wall of the conductive housing in response to a second electrostatic field between a second pair of positive and negative electrodes with an electrical charge different then the first electrostatic field;
a power supply electrically coupled to the plurality of positive and negative electrodes, and configured and arranged to produce a series of alternating electrical fields between each pair of electrode plates;
a fluid flow pump coupled to an inlet of the conductive housing and configured and arranged to direct a flow of fluid into the electrostatic fluid filtration device;
a contaminant sensor coupled to the inlet or an outlet of the conductive housing and configured and arranged to detect the contaminant level of the fluid flowing past the contaminant sensor; and
controller circuitry configured and arranged to receive data from the fluid flow pump indicative of a fluid flow rate, receive data from the contaminant sensor indicative of fluid contaminant level, and to receive data indicative of an output of the power supply.

11. The system of claim 10, wherein the controller circuitry further includes communication circuitry configured and arranged to transmit data received by the controller circuitry to remote computer circuitry.

12. The system of claim 10, wherein the controller circuitry is further configured and arranged to control the fluid flow rate of the fluid flow pump, and output of the power supply in response to the data received from the contaminant sensor indicative of the contaminant level of the fluid flow.

13. The system of claim 10, further including a water sensor coupled to an inlet of the electrostatic fluid filtration device and configured and arranged to transmit data to the controller circuitry indicative of the existence of water within the fluid flow entering the electrostatic fluid filtration device, and
the controller circuitry further configured and arranged, in response to receiving data from the water sensor indicative of the existence of water within the fluid flow,
shutting down the fluid flow pump, and output of the power supply, and
indicating to an operator the need to insert another removable filter cartridge includes a second filter media configured and arranged to capture water from the fluid flow within the electrostatic fluid filtration device.

14. The system of claim 10, wherein the controller circuitry is configured and arranged to store data received from the fluid flow pump, the contaminant sensor, and the power supply, and based on the stored data characterize the degradation of the fluid being filtered by the electrostatic fluid filtration device.

15. The system of claim 14, wherein the controller circuitry if further configured and arranged to indicate to an operator that a fluid change is necessary once the degradation of the fluid exceeds a threshold level.

16. The system of claim 10, wherein the electrostatic fluid filtration device is further configured and arranged to reverse corrosion machine surfaces in contact with the fluid by reducing the contaminant level within the fluid below a contaminant saturation level wherein contaminants comprising the corrosion are drawn from the machine surfaces into the fluid whereby the contaminants are filtered by the electrostatic fluid filtration device.

17. The system of claim 10, wherein the plurality of positive and negative electrodes include surface area maximizing features.

18. The system of claim 10, further including a reservoir configured and arranged to hold the fluid, and wherein the reservoir is coupled to an inlet and outlet of the electrostatic fluid filtration device in a kidney loop configuration.
